(19) United States
(12) Patent Application Publication
(10) Pub. No.: US 2025/0357035 A1
(43) Pub. Date: Nov. 20, 2025

(54) INDUCTOR AND METHOD FOR MANUFACTURING INDUCTOR

(71) Applicant: Panasonic Intellectual Property Management Co., Ltd., Osaka (JP)

(72) Inventors: Mutsuyasu OTSUBO, Hyogo (JP); Ryotaro TSUGAWA, Hyogo (JP)

(73) Assignee: Panasonic Intellectual Property Management Co., Ltd., Osaka (JP)

(21) Appl. No.: 18/876,372

(22) PCT Filed: May 29, 2023
(86) PCT No.: PCT/JP2023/019904

§ 371 Date: Dec. 18, 2024

(30) Foreign Application Priority Data
Jun. 27, 2022 (JP) 2022-102841

(51) Int. Cl. H01F 27/04; H01F 27/255; H01F 27/28; H01F 41/02; H01F 41/061

(52) U.S. Cl. CPC H01F 27/04; H01F 27/255; H01F 27/2852; H01F 41/0206; H01F 41/061

(57) ABSTRACT

An inductor includes: a magnetic dust core including a first surface, a second surface opposite to the first surface, and at least one third surface that connects the first surface and the second surface; and a coil element made of a flat conductor wire. The coil element includes: a wound body portion disposed inside of the magnetic dust core; a draw-out portion drawn out from an end of the wound body portion toward the at least one third surface; and an electrode portion that is connected to the draw-out portion and protrudes from the at least one third surface to outside of the magnetic dust core. The draw-out portion includes a cutout that extends in a draw-out direction of the draw-out portion.

### TECHNICAL FIELD

The present disclosure relates to an inductor and a method for manufacturing an inductor.

### BACKGROUND ART

An inductor that is a passive element that stores electric energy as magnetic energy is used in, for example, a DC-DC converter device or the like for the purpose of smoothing step-up/step-down power supply voltage and DC current. The inductor is mounted, for example, on a surface of a circuit board or the like.

Patent Literature (PTL) 1 discloses an inductor including: a coil element made of a flat conductor wire; and a magnetic dust core in which a portion of the coil element is embedded. The magnetic dust core has a flat plate shape and is formed through press molding using a die. The coil element includes a wound body portion disposed inside of the magnetic dust core and an electrode portion provided outside of the magnetic dust core.

### CITATION LIST

### Patent Literature

[PTL 1]
Japanese Unexamined Patent Application Publication No. 2012-49435

### SUMMARY OF INVENTION

### Technical Problem

The inductor disclosed in PTL 1 is problematic in that, when forming the magnetic dust core through press molding, the wound body portion placed in the die may be inclined at an oblique angle to cause a portion of the flat conductor wire connecting the wound body portion and the electrode portion to twist, causing damage to the magnetic dust core and the like, and reducing the reliability of the inductor.

In view of the above, it is an object of the present disclosure to enhance the reliability of the inductor.

### Solution to Problem

An inductor according to an aspect of the present disclosure is an inductor including: a magnetic dust core including a first surface, a second surface opposite to the first surface, and at least one third surface that connects the first surface and the second surface; and a coil element made of a flat conductor wire, wherein the coil element includes: a wound body portion disposed inside of the magnetic dust core; a draw-out portion drawn out from an end of the wound body portion toward the at least one third surface; and an electrode portion that is connected to the draw-out portion and protrudes from the at least one third surface to outside of the magnetic dust core, and the draw-out portion includes a cutout that extends in a draw-out direction of the draw-out portion.

A method for manufacturing an inductor according to an aspect of the present disclosure is a method for manufacturing an inductor including: forming a coil element that includes a wound body portion obtained by winding a flat conductor wire; and forming a magnetic dust core that includes the coil element by placing a portion of the coil element and a magnetic material in a die and subjecting to press molding, wherein, in the forming of the magnetic dust core, the press molding is performed to provide the wound body portion and a draw-out portion drawn out from an end of the wound body portion inside of the magnetic dust core and an electrode portion connected to the draw-out portion outside of the magnetic dust core, and in the forming of the coil element, a cutout that extends in a draw-out direction of the draw-out portion is formed at a position at which the draw-out portion is to be formed in the forming of the magnetic dust core.

### Advantageous Effects of Invention

According to the present disclosure, the reliability of the inductor can be enhanced.

### BRIEF DESCRIPTION OF DRAWINGS

FIG. 1 is a perspective view of an inductor according to a comparative example.

FIG. 2 is a cross-sectional view of a coil element and a magnetic dust core included in the inductor according to the comparative example during manufacturing process.

FIG. 3 is a diagram showing an inductor according to an embodiment.

FIG. 4 is a diagram showing a draw-out portion and an electrode portion included in the inductor according to the embodiment when viewed from a direction opposite to the draw-out direction.

FIG. 5 is a flowchart illustrating a method for manufacturing an inductor according to an embodiment.

FIG. 6 is a diagram showing a coil element and a magnetic dust core included in the inductor according to the embodiment during manufacturing process.

FIG. 7 is a cross-sectional view of the coil element and the magnetic dust core included in the inductor according to the embodiment during manufacturing process.

FIG. 8 is a diagram showing an inductor according to Variation 1 of the embodiment.

FIG. 9 is a diagram showing an inductor according to Variation 2 of the embodiment.

FIG. 10 is a diagram showing an inductor according to Variation 3 of the embodiment.

FIG. 11 is a diagram showing an inductor according to Variation 4 of the embodiment.

FIG. 12 is a diagram showing an inductor according to Variation 5 of the embodiment.

FIG. 13 is a perspective view of an inductor according to Variation 6 of the embodiment.

### DESCRIPTION OF EMBODIMENTS

### Circumstances Leading to the Present Disclosure

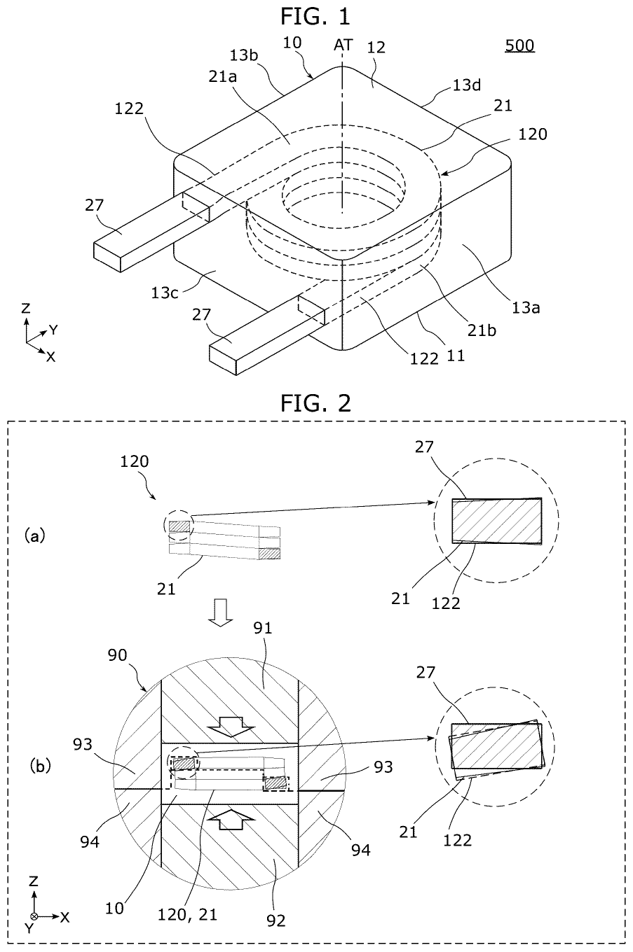

The circumstances leading to the present disclosure will be described with reference to FIGS. 1 and 2.

FIG. 1 is a perspective view of inductor 500 according to a comparative example.

As shown in FIG. 1, inductor 500 of the comparative example includes coil element 120 made of a flat conductor wire and magnetic dust core 10 in which a portion of coil element 120 is embedded.

Magnetic dust core 10 has a rectangular parallelepiped shape and is formed through press molding using a die. Magnetic dust core 10 includes first surface 11, second surface 12 that faces first surface 11, and four third surfaces 13a, 13b, 13c, and 13d that connect first surface 11 and second surface 12.

Coil element 120 includes wound body portion 21 provided in magnetic dust core 10, two draw-out portions 122, and two electrode portions 27 provided outside of magnetic dust core 10. Wound body portion 21 is formed by winding a flat conductor wire that has a rectangular cross section with a long side and a short side into a shape in which the short side is parallel to winding axis AT and adjacent surfaces of the flat conductor wire including the long side overlap. One of the two draw-out portions 122 is drawn out from one end 21a of wound body portion 21 toward third surface 13c of magnetic dust core 10, and the other one of the two draw-out portions 122 is drawn out from another end 21b of wound body portion 21 toward third surface 13c of magnetic dust core 10. Two electrode portions 27 are connected to draw-out portions 122 at third surface 13c, respectively, and protrude horizontally (in the Y axis direction in FIG. 1) outward from third surface 13c.

FIG. 2 is a cross-sectional view of coil element 120 and magnetic dust core 10 included in inductor 500 of the comparative example during manufacturing process. (a) in FIG. 2 shows coil element 120 before press molding, and (b) in FIG. 2 shows coil element 120 and magnetic dust core 10 after press molding. Note that FIG. 2 shows coil element 120 and magnetic dust core 10 when viewed from a direction (the Y axis direction) perpendicular to third surface 13a. In FIG. 2, electrode portions 27, punches 91 and 92, and dies 93 and 94 are hatched, but wound body portion 21, draw-out portions 22, and magnetic dust core 10 are not hatched.

Wound body portion 21 has a spiral shape in which, when viewed in cross section in (a) in FIG. 2, the flat conductor wire is stacked each turn. For example, in the case where wound body portion 21 (a thin line in (a) in FIG. 2) is a left-handed wound body portion, wound body portion 21 is asymmetric in the left-right direction, with the left side being raised upward and the right side being positioned downward.

For this reason, when press molding is performed by placing a portion (wound body portion 21 and draw-out portions 122) of coil element 120 in die 90 so as to align winding axis AT of wound body portion 21 in the pressing direction of the press molding, together with a mixture of a magnetic material powder and a binder to form magnetic dust core 10, as shown in (b) in FIG. 2, due to the pressure applied by upper and lower punches 91 and 92, wound body portion 21 and each draw-out portion 122 (indicated by a broken line in an enlarged view shown in (b) in FIG. 2) slightly rotate counterclockwise and inclined. On the other hand, during press molding, each electrode portion 27 (indicated by a solid line in the enlarged view shown in (b) in FIG. 2) is sandwiched by upper die 93 and lower die 94, and fixed in the horizontal direction, and thus draw-out portion 122 between wound body portion 21 and electrode portion 27 is counterclockwise twisted in shape.

Accordingly, during press molding, draw-out portions 122 are twisted, and a shear force is generated between dies 93 and 94 and the material (the mixture of the magnetic material powder and the binder) of magnetic dust core 10 that moves as it is pressed by press molding. Also, shear damage may occur partially in a connecting portion where draw-out portion 122 and electrode portion 27 are connected (in the enlarged view shown in FIG. 2, a portion where electrode portion 27 (hatched portion) and draw-out portion 122 (a portion surrounded by a broken line) do not overlap). Also, after press molding, when draw-out portion 122 fixed by dies 93 and 94 is released from the fixed state, due to a residual stress in the twist direction (a spring-back force that causes twisted draw-out portion 122 to return to its original shape) that remains in draw-out portion 122, a portion of magnetic dust core 10 around draw-out portion 122 may be cracked and damaged. As described above, the inductor according to the comparative example is problematic in that the reliability of inductor 500 is reduced as a result of draw-out portion 122 being twisted.

The inductor according to the present disclosure has the following configuration in order to enhance the reliability of the inductor. Hereinafter, an embodiment will be described more specifically with reference to the drawings.

The embodiments described below show specific examples of the present disclosure. Accordingly, the numerical values, shapes, materials, structural elements, the arrangement and connection of the structural elements, steps, the order of the steps, and the like shown in the following embodiments are merely examples, and therefore are not intended to limit the scope of the present disclosure. Also, among the structural elements described in the following embodiments, structural elements not recited in any one of the independent claims are described as arbitrary structural elements.

Also, in the specification of the present application, the terms that describe the relationship between elements such as “parallel”, the terms that describe the shape of an element such as “rectangular parallelepiped”, and numerical value ranges are expressions that not only have a strict meaning but also encompass a substantially equal range including, for example, a margin of about several percent.

Also, the diagrams are schematic representations in which emphasis, omission, and scaling adjustment are applied as appropriate for the sake of clearly showing the present disclosure, and thus are not necessarily true to scale. Accordingly, the shape, the positional relationship, and the scale may be different from the actual shape, the actual positional relationship, and the actual scale. Also, in the diagrams, structural elements that are substantially the same are given the same reference numerals, and a redundant description may be omitted or simplified.

Also, in the diagrams, three directions that are orthogonal to each other such as the X axis, the Y axis, and the Z axis may be shown where necessary to describe the axes and the axis directions that extend along the axes. Note that the axes are shown to describe the present disclosure, and thus are not intended to limit the direction and the orientation of the inductor when it is used.

Also, in the specification of the present application, the terms that describe the configuration of the inductor such as “second surface” and “first surface” are not necessarily used to indicate second surface (vertically upper surface) and first surface (vertically lower surface) recognized in an absolute space, and are also used to define a relative positional relationship between structural elements of the inductor.

### EMBODIMENT

### [Configuration of Inductor]

A configuration of an inductor according to an embodiment will be described. The inductor is a passive element that stores electric energy flowing through a coil element as magnetic energy.

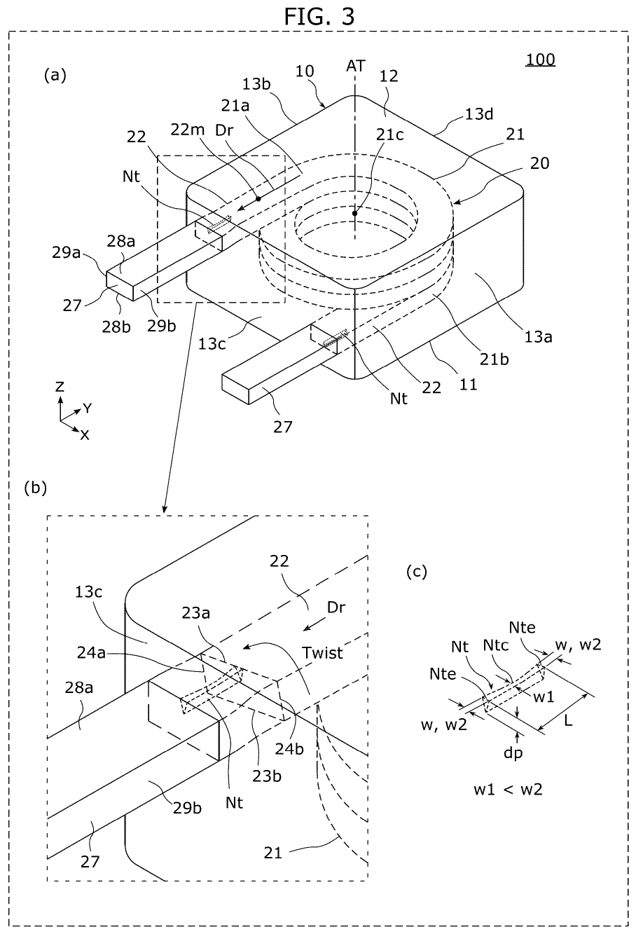

FIG. 3 is a diagram showing inductor 100 according to the embodiment. (a) in FIG. 3 shows a perspective view of inductor 100, (b) in FIG. 3 shows an enlarged view showing the vicinity of draw-out portion 22 of inductor 100, and (c) in FIG. 3 shows an extracted view of cutout Nt from (b) in FIG. 3.

As shown in (a) in FIG. 3, inductor 100 includes: coil element 20 made of a flat conductor wire; and magnetic dust core 10 in which a portion of coil element 20 is embedded. In (a) in FIG. 3, a portion of coil element 20 embedded in magnetic dust core 10 is indicated by a broken line.

An approximate outer shape of inductor 100 is determined by, for example, the shape of magnetic dust core 10 that is a rectangular parallelepiped shaped magnetic molded body. Magnetic dust core 10 can be formed in any shape through die molding. That is, inductor 100 of a desired shape can be obtained by controlling the shape of magnetic core 10 during molding. Magnetic dust core 10 according to the present embodiment has, for example, a dimension in the X axis direction of 40 mm, a dimension in the Y axis direction of 40 mm, and a dimension in the Z axis direction of 18 mm. The dimensions of magnetic dust core 10 can be selected as appropriate from the following ranges: a dimension in the X axis direction of 17 mm or more and 70 mm or less; a dimension in the Y axis direction of 17 mm or more and 70 mm or less; and a dimension in the Z axis direction of 7 mm or more and 50 mm or less.

Magnetic dust core 10 is an outer shell portion of inductor 100, and covers a portion of coil element 20. Magnetic dust core 10 is a magnetic dust core that contains a magnetic material, and is formed using, for example, a metal magnetic material powder, a resin material, and the like. It is sufficient that magnetic dust core 10 is formed using a magnetic material. As the magnetic material, ferrite may be used, or any other magnetic material may be used. As the metal magnetic material powder, a particulate material that has a predetermined elemental composition such as an Fe—Si—Al-based material powder, an Fe—Si-based material powder, an Fe—Si—Cr-based material powder, or an Fe—Si—Cr—B-based material powder is used. As the resin material, a material that can bind metal magnetic material powder particles while providing insulation between the metal magnetic material powder particles, and can thereby retain a predetermined shape such as a silicone-based resin is selected.

Magnetic dust core 10 has, for example, a rectangular parallelepiped shape. Magnetic dust core 10 includes first surface 11, second surface 12 opposite to first surface 11, and four third surfaces 13a, 13b, 13c, and 13d that connect first surface 11 and second surface 12. In magnetic dust core 10 shown in FIG. 3, four third surfaces 13a to 13d form the outer side surfaces of magnetic dust core 10.

Third surface 13a and third surface 13b are provided side by side and facing each other in the X axis direction. Third surface 13c and third surface 13d are provided side by side and facing each other in the Y axis direction. First surface 11, second surface 12, and third surfaces 13a, 13b, 13c, and 13d are substantially flat surfaces. A pair of first surface 11 and second surface 12, a pair of third surface 13a and third surface 13b, and a pair of third surface 13c and third surface 13d are in a substantially parallel relationship to each other. First surface 11 and second surface 12 extend in a direction that intersects third surfaces 13a, 13b, 13c, and 13d, specifically, in a direction perpendicular to third surfaces 13a, 13b, 13c, and 13d. Also, third surface 13a and third surface 13b extend in a direction that intersects third surfaces 13c and 13d, specifically, in a direction perpendicular to third surfaces 13c and 13d.

Coil element 20 includes wound body portion 21 provided in magnetic dust core 10, a plurality of draw-out portions 22, and a plurality of electrode portions 27 provided outside of magnetic dust core 10.

Coil element 20 is formed using, for example, a flat conductor wire that is a flat wire that has a rectangular cross section. The conductor wire includes a metal wire and an insulation coating that covers the metal wire. The metal wire is made of a metal material selected from, for example, metals such as aluminum, copper, silver, and gold, alloys that contain one or more of these metals, materials composed of any of the metals or the alloys and other substances, and the like. Specifically, the conductor wire is, for example, a copper wire covered with an insulation coating. Here, the terms “wound body portion 21”, “draw-out portions 22”, and “electrode portions 27” refer to, for example, different portions of a formed body obtained by processing one member made of the same material.

Coil element 20 according to the present embodiment includes one wound body portion 21, a pair of draw-out portions 22 connected to opposing ends of wound body portion 21, and a pair of electrode portions 27 connected to the pair of draw-out portions 22 in one-to-one correspondence.

Wound body portion 21 is a portion covered with magnetic dust core 10. Wound body portion 21 is formed by winding a conductor wire, and functions as a coil. Wound body portion 21 is embedded in magnetic dust core 10 such that winding axis AT of wound body portion 21 intersects first surface 11 and second surface 12. When viewed from a direction perpendicular to third surface 13c, one end 21a that is one of the opposing ends of wound body portion 21 is on the minus side of the X axis, which is the outer left side of winding axis AT, and another end 21b that is the other one of the opposing ends of wound body portion 21 is on the plus side of the X axis, which is the outer right side of winding axis AT.

The conductor wire for forming wound body portion 21 has a rectangular cross section with, for example, a long side length of 6.0 mm and a short side length of 3.0 mm. Wound body portion 21 is formed by the flat conductor wire being wound such that the short side is parallel to winding axis AT and adjacent surfaces of the flat conductor wire including the long sides are stacked. There is no particular limitation on the number of windings of wound body portion 21. The number of windings of wound body portion 21 is selected as appropriate according to constraints such as the required performance for inductor 100 and the size of magnetic dust core 10, and may be, for example, 1.5 turns to 10 turns. In practice, as a result of wound body portion 21 being formed by winding around winding axis AT, wound body portion 21 is thick on the inner circumferential side and thin on the outer circumferential side. For this reason, the conductor wire for forming wound body portion 21 is configured to have a trapezoidal cross section whose lower base is on the inner circumferential side and upper base is on the outer circumferential side.

The pair of electrode portions 27 are portions that are connected to a wiring pattern or the like formed on a circuit board when inductor 100 is mounted on the circuit board. The pair of electrode portions 27 includes one electrode portion 27 and another electrode portion 27. Electrode portions 27 are formed by removing the insulation coating on the surface of the conductor wire. The portion of each electrode portion 27 from which the insulation coating has been removed may be solder plated.

Electrode portions 27 protrude horizontally (in the Y axis direction in FIG. 1) outward from third surface 13c of magnetic dust core 10. That is, electrode portions 27 protrude from third surface 13c that is the same one of the plurality of third surfaces 13a to 13d.

Electrode portions 27 are portions of the above-described conductor wire, and have a rectangular cross section. Each electrode portion 27 includes: two long sides 28a and 28b; and two short sides 29a and 29b that connect the two long sides 28a and 28b. Two long sides 28a and 28b are parallel to first surface 11 and second surface 12, and two short sides 29a and 29b are parallel to third surfaces 13a and 13b. Electrode portions 27 are connected to draw-out portions 22 at third surface 13c of magnetic dust core 10.

The pair of draw-out portions 22 are portions that connect wound body portion 21 and electrode portions 27. The pair of draw-out portions 22 includes: one draw-out portion 22 provided between one end 21a of wound body portion 21 and one electrode portion 27; and another draw-out portion 22 provided between another end 21b of wound body portion 21 and another electrode portion 27. Each draw-out portion 22 is drawn out linearly from the end of wound body portion 21 toward third surface 13c of magnetic dust core 10. That is, each draw-out portion 22 is drawn out toward third surface 13c that is the same one of four third surfaces 13a to 13d.

Hereinafter, a direction in which draw-out portions 22 are drawn out from out wound body portion 21 toward third surface 13c of magnetic dust core 10 will be referred to as “draw-out direction Dr”. Draw-out direction Dr is parallel to first surface 11, second surface 12, and third surfaces 13a and 13b, and perpendicular to third surfaces 13c and 13d. In FIG. 3, draw-out direction Dr is opposite to the arrow indicating the Y axis direction.

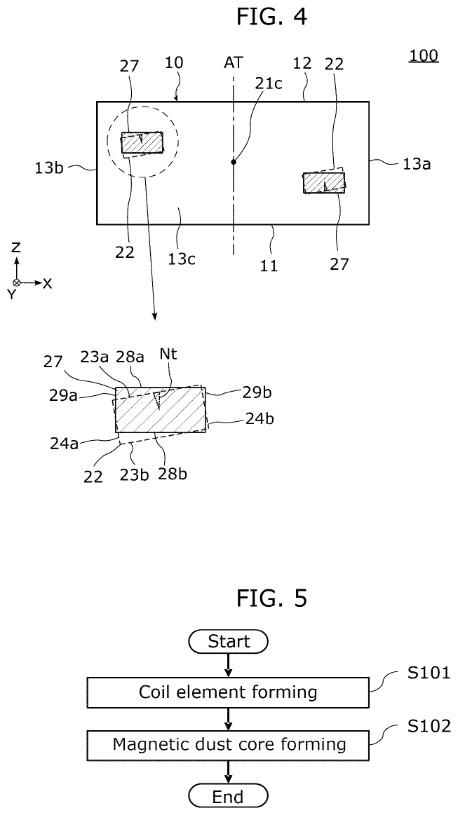

When viewed from a direction (the Y axis direction) opposite to draw-out direction Dr, one draw-out portion 22 and one electrode portion 27 are provided on the minus side of the X axis that is the outer left side of winding axis AT and on the plus side of the Z axis relative to the height of center 21c (see FIG. 4) of wound body portion 21 that is closer to second surface 12. Likewise, another draw-out portion 22 and another electrode portion 27 are provided on the plus side of the X axis that is the outer right side of winding axis AT and on the minus side of the Z axis relative to the height of center 21c of wound body portion 21 that is closer to first surface 11. As used herein, the term “center 21c of wound body portion 21” refers to a point that is located on winding axis AT and a midpoint between the height positions of opposing ends of wound body portion 21 in the axis direction of winding axis AT.

The following description will be given focusing mainly on a half of inductor 100 on the minus side of the X axis. However, the description can also be applied to another half of inductor 100 on the plus side of the X axis because it has the same structure as that of the half of inductor 100 on the minus side of the X axis.

In the present embodiment, cutout Nt is formed in draw-out portion 22 in order to suppress the reduction of the reliability of inductor 100 caused by draw-out portion 22 being twisted during press molding. As a result of cutout Nt being formed in draw-out portion 22, draw-out portion 22 has a twistable structure. With this configuration, it is possible to reduce a force in the twist direction generated in draw-out portion 22 as a result of wound body portion 21 being inclined relative to electrode portion 27 during press molding.

Cutout Nt is a groove formed to extend in draw-out direction Dr. Cutout Nt is a notch groove, and has a V-shaped cross section perpendicular to draw-out direction Dr. For example, cutout Nt is formed by making a cut in draw-out portion 22 using a cutter with a V-shaped cross section. The cutter forms cutout Nt by pushing out the conductor wire material in a direction along the cross section, and thus the cross-sectional area of the conductor wire, which functions as an electric path for draw-out portion 22, remains the same before and after cutout Nt is formed. In the portion where cutout Nt has been formed, the insulation coating of the conductor wire has been removed by the cutter, and thus the conductor wire material is exposed. An insulating resin may be applied to the portion where the conductor wire material is exposed.

Cutout Nt is provided between midpoint 22m of draw-out portion 22 in draw-out direction Dr and third surface 13c. As used herein, the term “midpoint 22m of draw-out portion 22 in draw-out direction Dr” refers to the position of the center of a line that connects one end of draw-out portion 22 that is connected to wound body portion 21 and another end of draw-out portion 22 that is in contact with third surface 13c. Cutout Nt according to the present embodiment is in contact with third surface 13c, but is not in contact with midpoint 22m of draw-out portion 22. That is, cutout Nt is provided at a position closer to third surface 13c than to midpoint 22m of draw-out portion 22. During press molding, a force in the twist direction is applied to draw-out portion 22 provided between wound body portion 21 and electrode portion 27, and a region of draw-out portion 22 where cutout Nt has been formed is mainly twisted.

As shown in (b) in FIG. 3, draw-out portion 22 has a rectangular cross section perpendicular to draw-out direction Dr. Draw-out portion 22 has a twisted shape, and thus, strictly speaking, draw-out portion 22 may have a portion where the cross section is not rectangular. However, the following description will be given assuming that draw-out portion 22 has a cross section that is similar to rectangular in shape.

FIG. 4 is a diagram showing draw-out portion 22 and electrode portion 27 when viewed from a direction opposite to draw-out direction Dr. An enlarged view shown in FIG. 4 shows a cross section of electrode portion 27 and a cross section of the vicinity of one end of draw-out portion 22 connected to one end 21a of wound body portion 21. Only electrode portion 27 is hatched in the diagram.

As shown in FIG. 4, draw-out portion 22 includes: two long sides 23a and 23b; and two short sides 24a and 24b that connect the two long sides 23a and 23b. When viewed from a direction opposite to draw-out direction Dr, out of the two long sides, outer long side 23a is located at a position that is closer to second surface 12 and farther away from center 21c of wound body portion 21 than inner long side 23b is. Likewise, out of the two short sides, outer short side 24a is located at a position that is closer to third surface 13b and farther away from winding axis AT and center 21c of wound body portion 21 than inner short side 24b is.

Draw-out portion 22 is twisted at the region where cutout Nt has been formed. Accordingly, when viewed from a direction opposite to draw-out direction Dr, long side 23a of draw-out portion 22 intersects long side 28a of electrode portion 27. An intersecting angle at which long side 23a and long side 28a intersect is, for example, 5° or more and 15° or less. Likewise, short side 24a of draw-out portion 22 intersects short side 29a of electrode portion 27. An intersecting angle at which short side 24a and short side 29a intersect is, for example, 5° or more and 15° or less. As used herein, the term “intersecting angle” refers to the acute angle out of the acute and obtuse angles formed as a result of two sides intersecting each other.

Cutout Nt is provided at the center of long side 23a that is one of the two long sides of draw-out portion 22 provided on the outer side. If an exposed portion of the conductor wire material that is formed by cutout Nt being formed is close to wound body portion 21, it affects the reliability of inductor 100. Accordingly, it is desirable that cutout Nt is formed in long side 23a that is located farther away from center 21c of wound body portion 21.

As shown in (c) in FIG. 3, cutout length L in draw-out direction Dr is 0.5 times or more and 1.5 times or less of the length of long side 28a. When cutout length L is too short, draw-out portion 22 is less likely to be twisted during press molding. When cutout length L is too long, cutout Nt from which the insulation coating has been removed is located at a position close to center 21c of wound body portion 21, which affects the reliability of inductor 100.

Also, cutout length L in draw-out direction Dr is longer than cutout width w. Also, cutout Nt is configured to have a narrower width in cutout center portion Ntc than in cutout end portion Nte in draw-out direction Dr. That is, the cutout width has the following relationship: (width w2 in end portion Nte)> (width w1 in center portion Ntc). In the case where cutout Nt is a V-shaped groove, width w is the maximum width of cutout Nt on long side 23a.

Cutout depth dp is 1.0 times or more and 3.0 times or less of cutout width w. Also, cutout depth dp may be 0.2 times or more and 0.6 times or less of the short side dimension of the conductor wire that is the thickness of the conductor wire. As used herein, the term “depth dp” refers to, in the case where cutout Nt is a V-shaped groove, the maximum depth of cutout Nt with respect to long side 23a.

As described above, in the present embodiment, cutout Nt is formed in each draw-out portion 22 of coil element 20, and thus draw-out portion 22 has a twistable configuration. With this configuration, draw-out portion 22 can be easily twisted, and it is therefore possible to reduce, for example, the force in the twist direction generated in draw-out portion 22 as a result of wound body portion 21 being inclined relative to electrode portion 27 during press molding. For this reason, it is possible to suppress shear damage to a portion of the conductor wire that is a connecting portion where electrode portion 27 and draw-out portion 22 are connected. As a result, a further temperature increase during electricity conduction and a reduction of the strength of the electrode portion that are caused by the reduction of the cross-sectional area of the conductor wire due to the shear damage can be suppressed. Also, for example, a residual stress (a spring-back force that causes twisted draw-out portion 122 to return to its original shape) in the twist direction that remains in draw-out portion 22 after press molding can be reduced, and thus cracking and damage to a portion of magnetic dust core 10 around draw-out portion 22 can be suppressed. Accordingly, it is possible to suppress the reduction of the reliability of inductor 100.

### [Method for Manufacturing Inductor]

Next, a method for manufacturing inductor 100 configured as described above will be described with reference to FIGS. 5 to 7 where appropriate.

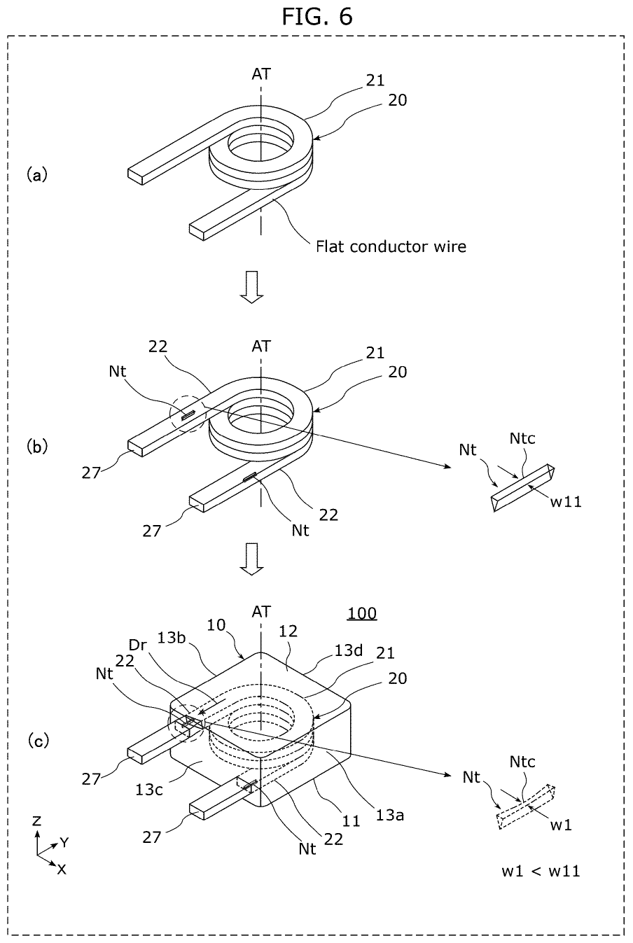

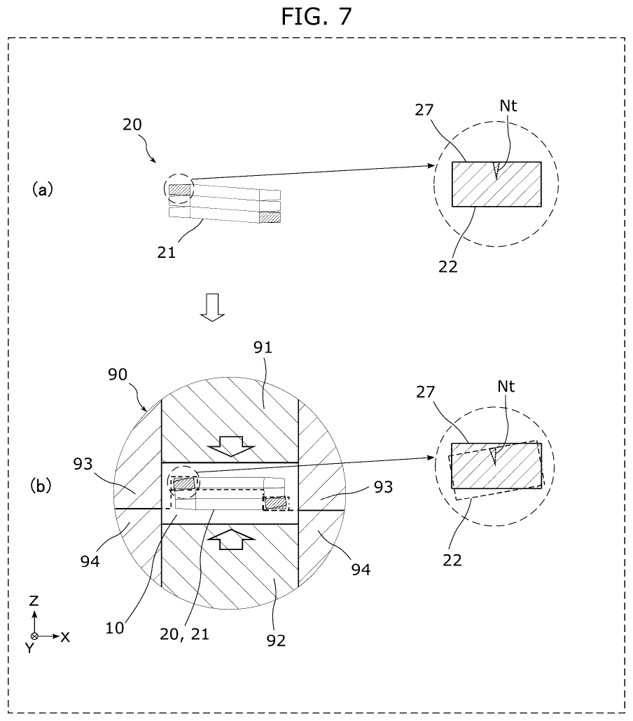

FIG. 5 is a flowchart illustrating a method for manufacturing inductor 100 according to an embodiment. FIG. 6 is a diagram showing coil element 20 and magnetic dust core 10 during manufacturing process of inductor 100 of the embodiment. FIG. 7 is a cross-sectional view of coil element 20 and magnetic dust core 10 during manufacturing process of inductor 100 of the embodiment.

As shown in FIG. 5, the method for manufacturing inductor 100 includes step S101 of forming a coil element and step S102 of forming a magnetic dust core.

In step S101 of forming a coil element, as shown in (a) in FIG. 6, wound body portion 21 is formed by winding a flat conductor wire. Specifically, wound body portion 21 is formed by winding a flat conductor wire counterclockwise for 2.5 turns around winding axis AT, with the short side of the flat conductor wire being on winding axis AT side. Wound body portion 21 has a spiral shape, and is asymmetric in the left-right direction, with the left side being raised upward and the right side being lowered when viewed in a cross-sectional view shown in (a) in FIG. 7. In practice, as a result of wound body portion 21 being formed by winding a flat conductor wire around winding axis AT, wound body portion 21 is thick on the inner circumferential side and thin on the outer circumferential side. For this reason, the conductor wire for forming wound body portion 21 is configured to have a trapezoidal cross section whose lower base is on the inner circumferential side and upper base is on the outer circumferential side.

Also, in step S101 of forming a coil element, cutouts Nt as shown in (b) in FIG. 6 are formed in regions where draw-out portions 22 are to be formed in the next step, specifically, step S102 of forming a magnetic dust core. Cutouts Nt are recesses formed by, for example, pressing a tool with a V-shaped cross section against draw-out portions 22. Through the pressing processing, cutouts Nt extending in the extension direction of the flat conductor wire are formed in the regions where draw-out portions 22 are to be formed. Cutout Nt is formed in each of a pair of draw-out portions 22. Cutouts Nt may be formed after wound body portion 21 has been formed, or may be formed before wound body portion 21 is formed.

In step S102 of forming a magnetic dust core, as shown in (c) in FIG. 6 and (b) in FIG. 7, magnetic dust core 10 is formed through press molding together with coil element 20. In this step, magnetic dust core 10 is formed by placing, in die 90, wound body portion 21 and draw-out portions 22 that correspond to a portion of coil element 20, then placing a mixture of a magnetic material powder and a binder so as to cover wound body portion 21 and draw-out portions 22, without covering electrode portions 27 that correspond to another portion of coil element 20, and press molding the whole. Specifically, the press molding is performed using die 90 that includes upper die 93 and lower die 94 for forming third surfaces 13a to 13d of magnetic dust core 10, punch 91 for forming first surface 11 of magnetic dust core 10, and punch 92 for forming second surface 12 of magnetic dust core 10. The portion of coil element 20 covered with magnetic dust core 10 are wound body portion 21 and draw-out portions 22, and the other portion of coil element 20 not covered with magnetic dust core 10 are electrode portions 27. The pressing force applied during press molding is set to, for example, 5 ton/cm², and the thermal curing temperature is set to, for example, 185° C.

First, wound body portion 21 is placed in die 90 so as to align winding axis AT of wound body portion 21 in the pressing direction of the press molding. However, because wound body portion 21 is asymmetric in the left-right direction, due to the pressure applied by punches 91 and 92 during press molding, wound body portion 21 slightly rotates counterclockwise and is inclined. Also, the flat conductor wire of wound body portion 21 deformed into a trapezoidal shape deforms to narrow the gap between adjacent flat conductor wire turns on the outer circumferential side. On the other hand, during press molding, electrode portions 27 are sandwiched by upper die 93 and lower die 94, and fixed in the horizontal direction, and thus draw-out portions 22 between wound body portion 21 and electrode portions 27 are counterclockwise twisted in shape. In the present embodiment, draw-out portions 22 have a twistable configuration because cutout Nt is formed in each draw-out portion 22 in advance. It is therefore possible to reduce the force in the twist direction generated in draw-out portions 22 when wound body portion 21 is inclined relative to electrode portions 27 during press molding.

Because each draw-out portion 22 is twisted counterclockwise, in cutout center portion Ntc in draw-out direction Dr, as shown in enlarged views in (b) and (c) in FIG. 6, width w1 after press molding is smaller than width w11 before press molding (w1<w11). Before press molding, the bottom portion of cutout Nt is linear in the extension direction of the flat conductor wire. However, after press molding, the bottom portion of cutout Nt is curved.

After press molding, electrode portions 27 not covered with magnetic dust core 10 protrude outward perpendicularly to third surface 13c of magnetic dust core 10. Electrode portions 27 are irradiated with, for example, a laser beam to remove the insulation coating. The regions of electrode portions 27 from which the insulation coating has been removed may be solder plated or the like where necessary. Through these steps, inductor 100 is produced.

### Variation 1 of Embodiment

Inductor 100A according to Variation 1 of the embodiment will be described. In Variation 1, an example will be described in which the cutout depth varies from place to place and is therefore not uniform.

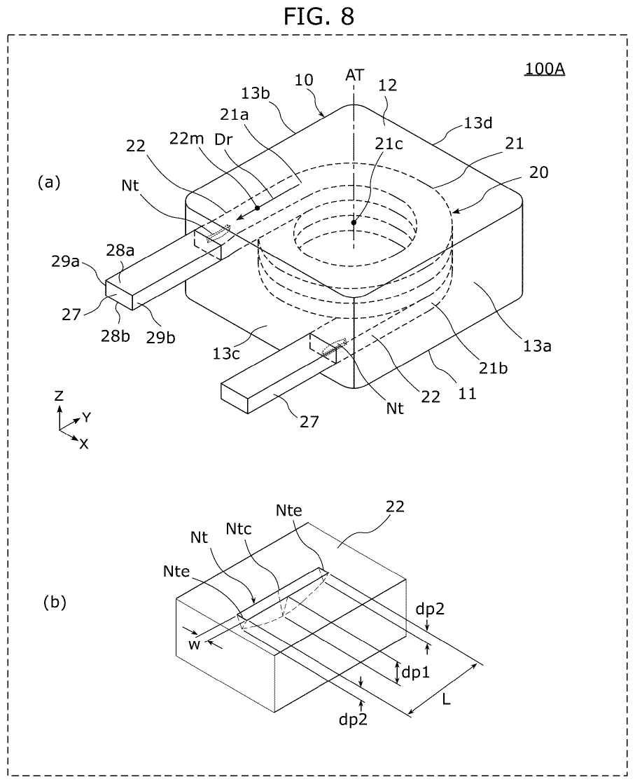

FIG. 8 is a diagram showing inductor 100A according to Variation 1 of the embodiment. (a) in FIG. 8 shows a perspective view of inductor 100A, and (b) in FIG. 8 shows an extracted view of the vicinity of cutout Nt from (a) in FIG. 8. In (b) in FIG. 8, cutout Nt that is a portion of the conductor wire before press molding and before a twisting force is applied to draw-out portion 22 is shown.

Inductor 100A according to Variation 1 includes: wound body portion 21; coil element 20 that includes draw-out portions 22 and electrode portions 27; and magnetic dust core 10 in which draw-out portion 22 and electrode portion 27 that correspond to a portion of coil element 20 are embedded. Cutout Nt is formed in each draw-out portion 22.

Cutout Nt of Variation 1 is also a groove formed to extend in draw-out direction Dr. Cutout Nt is a notch groove and has a V-shaped cross section perpendicular to draw-out direction Dr. As shown in (b) in FIG. 8, cutout Nt of Variation 1 is configured to have a greater depth in cutout center portion Ntc than in cutout end portion Nte in draw-out direction Dr. That is, the cutout depth has the following relationship: (depth dp 2 in end portion Nte)<(depth dp 1 in center portion Ntc).

Cutout Nt is formed by making a cut in draw-out portion 22 using a cutter with a V-shaped cross section. The tip end of the cutter (hereinafter referred to as “blade tip”) has a curved shape extending along a lengthwise direction of the cutter that is a direction perpendicular to a cross section of the cutter. When the cutter is viewed in a width direction perpendicular to the lengthwise direction immediately before a cut is made in draw-out portion 22, the center blade tip protrudes lower than the side blade tip, or in other words, the center blade tip protrudes toward draw-out portion 22. When the cutter is viewed from the width direction, the blade tip may have an elliptic curve shape or an arc curve shape. With the curved blade tip, cutout Nt can be easily formed.

In inductor 100A according to Variation 1 as well, cutout Nt extending in draw-out direction Dr is formed in each draw-out portion 22 of coil element 20. Accordingly, it is possible to suppress the reduction of the reliability of inductor 100A caused by draw-out portion 22 being twisted.

### Variation 2 of Embodiment

Inductor 100B according to Variation 2 of the embodiment will be described. In Variation 2, an example will be described in which cutout Nt is a through hole.

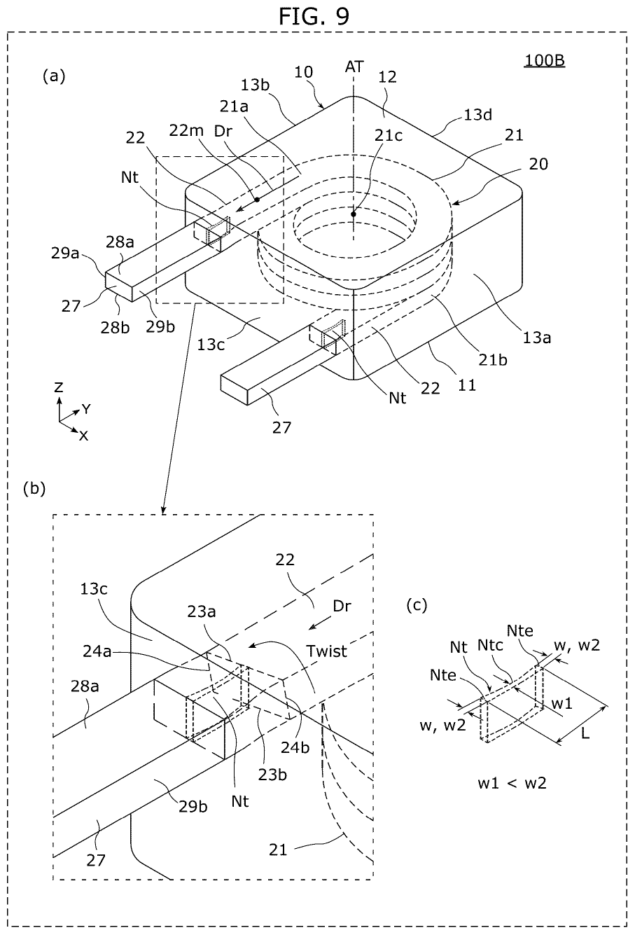

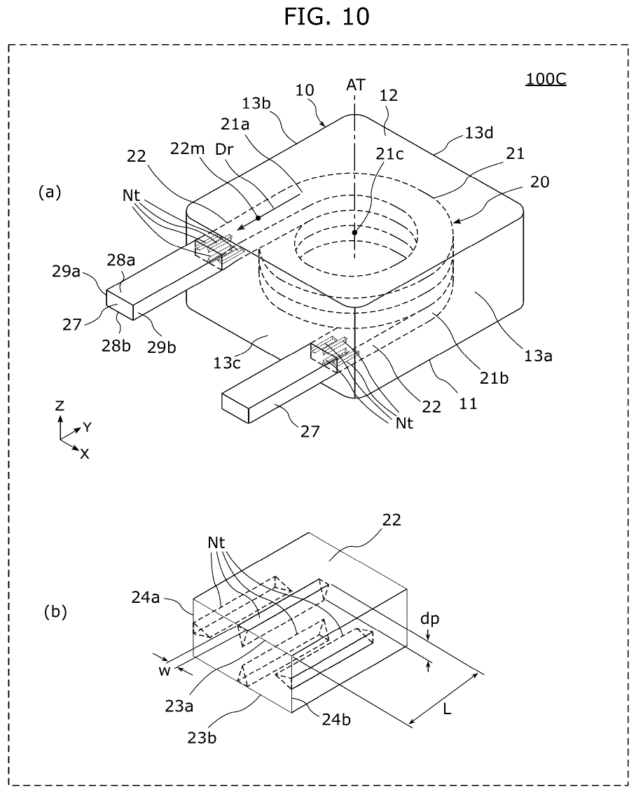

FIG. 9 is a diagram showing inductor 100B according to Variation 2 of the embodiment. (a) in FIG. 9 shows a perspective view of inductor 100B, (b) in FIG. 9 shows an enlarged view of the vicinity of draw-out portion 22 of inductor 100B, and (c) in FIG. 9 shows an extracted view of cutout Nt from (b) in FIG. 9.

Inductor 100B according to Variation 2 includes: wound body portion 21; coil element 20 that includes draw-out portions 22 and electrode portions 27; and magnetic dust core 10 in which draw-out portions 22 and electrode portions 27 that correspond to a portion of coil element 20 are embedded. Cutout Nt is formed in each draw-out portion 22.

Cutout Nt of Variation 2 is a through hole formed to extend in draw-out direction Dr. Cutout Nt has, for example, a rectangular hole shape or an elongated hole shape. Cutout length L in draw-out direction Dr is 0.5 times or more and 1.5 times or less of the length of long side 28a. Also, cutout length L in draw-out direction Dr is longer than cutout width w. Also, cutout Nt is configured to have a narrower width in cutout center portion Ntc than in cutout end portion Nte in draw-out direction Dr. That is, the cutout width has the following relationship: (width w2 in end portion Nte)> (width w1 in center portion Ntc). Cutout Nt is formed through laser processing, punching processing using a punch, or the like.

In inductor 100B according to Variation 2 as well, cutout Nt extending in draw-out direction Dr is formed in each draw-out portion 22 of coil element 20. Accordingly, it is possible to suppress the reduction of the reliability of inductor 100B caused by draw-out portion 22 being twisted.

### Variation 3 of Embodiment

Inductor 100C according to Variation 3 of the embodiment will be described. In Variation 3, an example will be described in which cutouts Nt are formed each in each one of two long sides and two short sides of each draw-out portion 22.

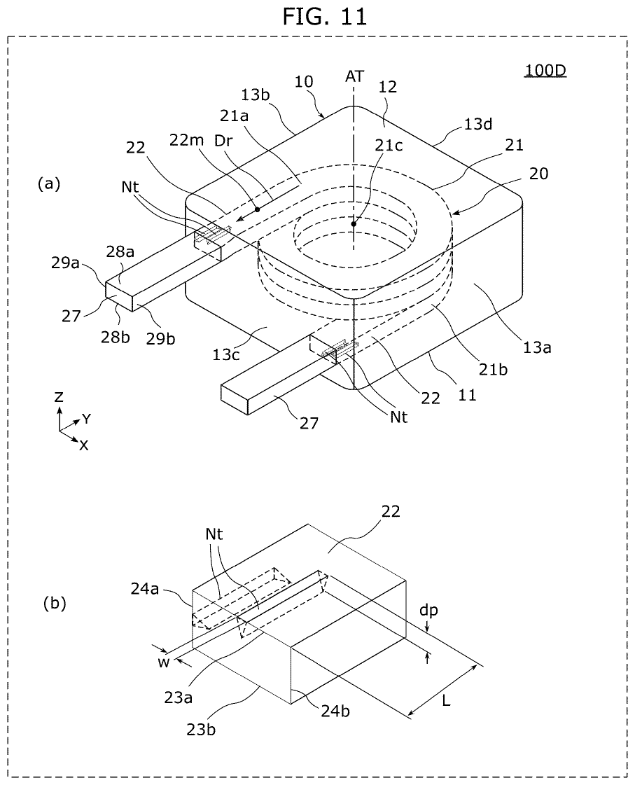

FIG. 10 is a diagram showing inductor 100C according to Variation 3 of the embodiment. (a) in FIG. 10 shows a perspective view of inductor 100C, and (b) in FIG. 10 shows an extracted view of the vicinity of cutouts Nt from (a) in FIG. 10. In (b) in FIG. 10, cutouts Nt that correspond to a portion of the conductor wire before press molding and before a twisting force is applied to draw-out portion 22 are shown.

Inductor 100C according to Variation 3 includes: wound body portion 21; coil element 20 that includes draw-out portions 22 and electrode portions 27; and magnetic dust core 10 in which draw-out portions 22 and electrode portions 27 that correspond to a portion of coil element 20 are embedded. Cutouts Nt are formed in each draw-out portion 22.

Cutouts Nt of Variation 3 are also grooves formed to extend in draw-out direction Dr. Cutouts Nt are notch grooves and have a V-shaped cross section perpendicular to draw-out direction Dr. Cutout depth dp of each cutout Nt is 0.5 times or more and 1.5 times or less of cutout width w. Cutout depth dp of each cutout Nt may be 0.1 times or more and 0.3 times or less of the short side dimension of the conductor wire that is the thickness of the conductor wire.

In Variation 3, four cutouts Nt are formed in each draw-out portion 22. Specifically, cutouts Nt are formed at the center of long side 23a, at the center of long side 23b, at the center of short side 24a, and at the center of short side 24b, respectively. Cutout Nt formed in long side 23a and cutout Nt formed in long side 23b are provided such that V-shaped tip ends of the two cutouts Nt face each other in a direction parallel to the short side of draw-out portion 22, and the distance between the V-shaped tip ends of the two cutouts Nt is shorter than the long side of draw-out portion 22. Likewise, cutout Nt formed in short side 24a and cutout Nt formed in short side 24b are provided such that V-shaped tip ends of the two cutouts Nt face each other in a direction parallel to the long side of draw-out portion 22, and the distance between the V-shaped tip ends of the two cutouts Nt is shorter than the short side of draw-out portion 22. In Variation 3, draw-out portion 22 has a cross-sectional shape that is even more twistable than that of the embodiment, and thus the force in the twist direction generated in draw-out portion 22 during press molding can be further reduced.

In inductor 100C according to Variation 3 as well, cutouts Nt extending in draw-out direction Dr are formed in each draw-out portion 22 of coil element 20. Accordingly, it is possible to suppress the reduction of the reliability of inductor 100C caused by draw-out portion 22 being twisted.

### Variation 4 of Embodiment

Inductor 100D according to Variation 4 of the embodiment will be described. In Variation 4, an example will be described in which cutouts Nt are formed in long side 23a that is one of the two long sides of draw-out portion 22 that is located farther away from center 21c of wound body portion 21 and in short side 24a that is one of the two short sides of draw-out portion 22 that is located farther away from winding axis AT, respectively.

FIG. 11 is a diagram showing inductor 100D according to Variation 4 of the embodiment. (a) in FIG. 11 shows a perspective view of inductor 100D, and (b) in FIG. 11 shows an extracted view of the vicinity of cutouts Nt from (a) in FIG. 11. In (b) in FIG. 11, cutouts Nt that correspond to a portion of the conductor wire before press molding and before a twisting force is applied to draw-out portion 22 are shown.

Inductor 100D according to Variation 4 includes: wound body portion 21; coil element 20 that includes draw-out portions 22 and electrode portions 27; and magnetic dust core 10 in which draw-out portions 22 and electrode portions 27 that correspond to a portion of coil element 20 are embedded. Cutouts Nt are formed in each draw-out portion 22.

Cutouts Nt of Variation 4 are also grooves formed to extend in draw-out direction Dr. Cutouts Nt are notch grooves and have a V-shaped cross section perpendicular to draw-out direction Dr.

In Variation 4, two cutouts Nt are formed in each draw-out portion 22. Specifically, one of the two cutouts Nt is formed in long side 23a that is one of two long sides of draw-out portion 22 that is located on the outer side and farther away from center 21c of wound body portion 21. The other one of the two cutouts Nt is formed in short side 24a that is one of two short sides of draw-out portion 22 that is located on the outer side and farther away winding axis AT (or center 21c) of wound body portion 21. For example, in the portions where cutouts Nt have been formed, the insulation coating of the conductor wire is removed, and thus the conductor wire material is exposed. However, by forming cutouts Nt in long side 23a and short side 24a that are farther away from center 21c or winding axis AT of wound body portion 21 than their other sides, it is possible to suppress the influence on the reliability of inductor 100D.

In inductor 100D according to Variation 4 as well, cutouts Nt extending in draw-out direction Dr are formed in each draw-out portion 22 of coil element 20. Accordingly, it is possible to suppress the reduction of the reliability of inductor 100D caused by draw-out portion 22 being twisted.

### Variation 5 of Embodiment

Inductor 100E according to Variation 5 of the embodiment will be described. In Variation 5, an example will be described in which cutout Nt is provided at a position in close proximity to third surface 13c, without being in contact with third surface 13c.

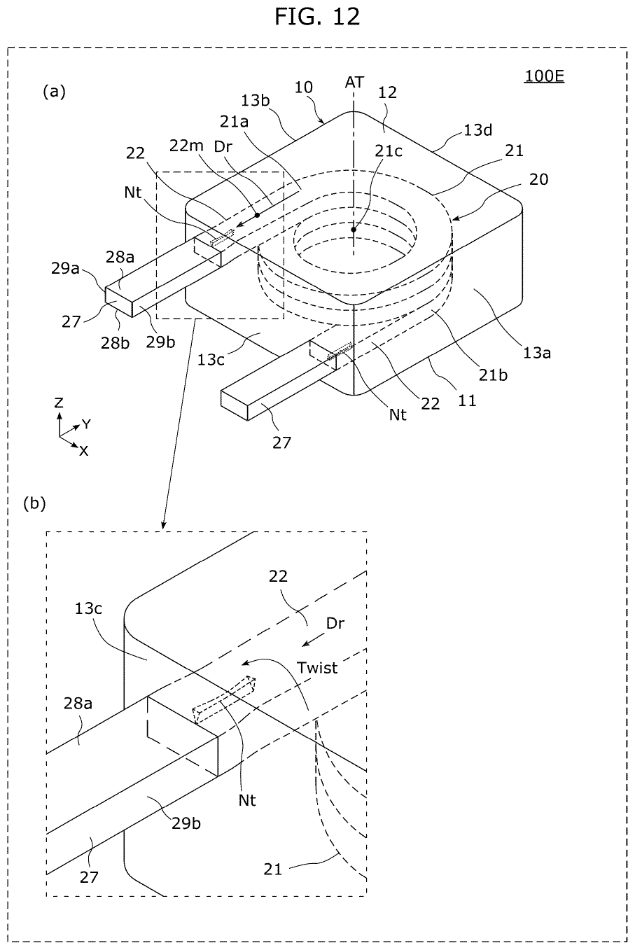

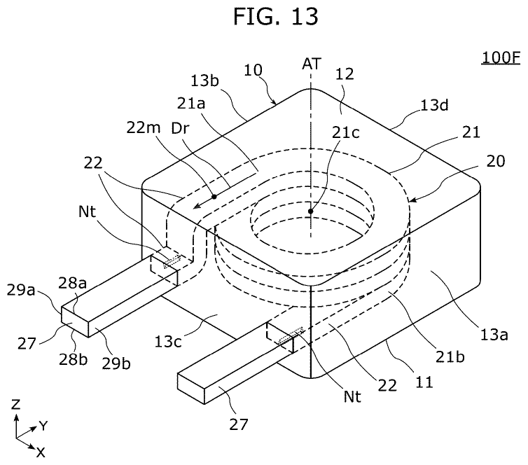

FIG. 12 is a diagram showing inductor 100E according to Variation 5 of the embodiment. (a) in FIG. 12 shows a perspective view of inductor 100E, and (b) in FIG. 12 shows an enlarged view of the vicinity of draw-out portion 22 of inductor 100E.

Inductor 100E according to Variation 5 includes: wound body portion 21; coil element 20 that includes draw-out portions 22 and electrode portions 27; and magnetic dust core 10 in which draw-out portions 22 and electrode portions 27 that correspond to a portion of coil element 20 are embedded. Cutout Nt is formed in each draw-out portion 22.

Cutout Nt of Variation 5 is also a groove formed to extend in draw-out direction Dr. Cutout Nt is a notch groove and has a V-shaped cross section perpendicular to draw-out direction Dr.

Cutout Nt of Variation 5 is provided between midpoint 22m of each draw-out portion 22 in draw-out direction Dr and third surface 13c. Cutout Nt of Variation 5 is provided at a position closer to third surface 13c than to midpoint 22m of draw-out portion 22, but is not in contact with third surface 13c. That is, cutout Nt is provided at a position in close proximity to third surface 13c. The distance between third surface 13c and cutout end portion Nte that is closest to third surface 13c is, for example, 0.1 mm or more and 0.5 mm or less. For example, if cutout Nt is provided outside of third surface 13c, the magnetic material powder may be forced out of die 90 from cutout Nt during press molding. However, by properly forming cutout Nt at a position between midpoint 22m of draw-out portion 22 and third surface 13c, it is possible to suppress a situation in which the magnetic material powder is forced out of die 90.

In inductor 100E according to Variation 5 as well, cutout Nt extending in draw-out direction Dr is formed in each draw-out portion 22 of coil element 20. Accordingly, it is possible to suppress the reduction of the reliability of inductor 100E caused by draw-out portion 22 being twisted.

### Variation 6 of Embodiment

Inductor 100F according to Variation 6 of the embodiment will be described. In Variation 6, an example will be described in which one electrode portion 27 is provided at the same height as another electrode portion 27.

FIG. 13 is a perspective view of inductor 100F according to Variation 6.

Inductor 100F according to Variation 6 includes: wound body portion 21; coil element 20 that includes draw-out portions 22 and electrode portions 27; and magnetic dust core 10 in which the pair of draw-out portions 22 and the pair of electrode portions 27 that correspond to a portion of coil element 20 are embedded. Cutout Nt is formed in each draw-out portion 22.

As shown in FIG. 13, the pair of draw-out portions 22 are connected to opposing ends of wound body portion 21, and drawn out toward third surface 13c of magnetic dust core 10. One of the pair of draw-out portions 22 is drawn out from one end 21a of wound body portion 21 toward third surface 13c, bent toward first surface 11 along third surface 13c at a position immediately preceding third surface 13c, further bent along first surface 11 at a position immediately preceding first surface 11, and drawn out toward third surface 13c.

One of the pair of electrode portions 27 is connected to one of the pair of draw-out portions 22 at third surface 13c, and protrudes outward from third surface 13c. The one of the pair of electrode portions 27 is provided at the same height as the other one of the pair of electrode portions 27. The other one of the pair of draw-out portions 22 and the other one of the pair of electrode portions 27 have the same configurations as those of draw-out portions 22 and electrode portions 27 of the embodiment.

Cutout Nt of Variation 6 is also a groove formed to extend in draw-out direction Dr. Cutout Nt is a notch groove and has a V-shaped cross section perpendicular to draw-out direction Dr. Cutout Nt of Variation 6 is provided in a region of one of the pair of draw-out portions 22 that extends in draw-out direction Dr and is in contact with third surface 13c, or in other words, the region being where draw-out portion 22 is bent along first surface 11 and drawn out toward third surface 13c. Cutout Nt of Variation 6 is provided between midpoint 22m of one of the pair of draw-out portions 22 in draw-out direction Dr and third surface 13c when viewed from a direction perpendicular to second surface 12.

Cutout Nt of Variation 6 is provided in one of two long sides of one of the pair of draw-out portions 22 that faces second surface 12. However, the configuration is not limited thereto, and cutout Nt of Variation 6 may be provided in the long side that faces first surface 11.

In inductor 100F according to Variation 6 as well, cutout Nt extending in draw-out direction Dr is formed in each draw-out portion 22 of coil element 20. Accordingly, it is possible to suppress the reduction of the reliability of inductor 100F caused by draw-out portion 22 being twisted.

### CONCLUSION

As described above, inductor 100 according to the present embodiment includes: magnetic dust core 10 including first surface 11, second surface 12 opposite to first surface 11, and at least one third surface (for example, 13c) that connects first surface 11 and second surface 12; coil element 20 made of a flat conductor wire. Coil element 20 includes: wound body portion 21 provided in magnetic dust core 10; draw-out portion 22 drawn out from an end of wound body portion 21 toward third surface 13c; and electrode portion 27 that is connected to draw-out portion 22 and protrudes from third surface 13c to outside of magnetic dust core 10. Draw-out portion 22 includes cutout Nt that extends in draw-out direction Dr of draw-out portion 22.

In inductor 100 according to the present embodiment, cutout Nt is provided in draw-out portion 22 of coil element 20, and thus draw-out portion 22 has a twistable configuration. With this configuration, for example, it is possible to reduce a force in the twist direction generated in draw-out portion 22 as a result of wound body portion 21 being inclined relative to electrode portion 27 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, cutout Nt may be a groove formed to extend in draw-out direction Dr.

With this configuration, draw-out portion 22 is configured to be twistable due to the groove, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

The groove may have a V-shaped cross section perpendicular to draw-out direction Dr.

With this configuration, draw-out portion 22 is configured to be twistable due to the V-shaped groove, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, cutout Nt may be a through hole formed to extend in draw-out direction Dr.

With this configuration, draw-out portion 22 is configured to be twistable due to the through hole, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100B.

Also, cutout Nt may be in contact with third surface 13c.

With this configuration, draw-out portion 22 is configured to be twistable at third surface 13c, and it is therefore possible to reduce a force in the twist direction generated between electrode portion 27 and draw-out portion 22 during press molding. For this reason, it is possible to suppress shear damage to the conductor wire at the connecting portion where draw-out portion 22 and electrode portion 27 are connected. Accordingly, it is possible to suppress the reduction of the reliability of inductor 100.

Also, draw-out portion 22 has a rectangular cross section perpendicular to draw-out direction Dr, and includes long sides 23a and 23b, and short sides 24a and 24b. Cutout Nt may be provided at the center of long side 23a (or 23b).

With this configuration, draw-out portion 22 is configured to be twistable in a symmetric manner in the left-right direction, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, when viewed from draw-out direction Dr, draw-out portion 22 may have a rectangular cross section, electrode portion 27 may have a rectangular cross section, and long side 23a of draw-out portion 22 and long side 28a of electrode portion 27 may intersect each other.

As described above, even when draw-out portion 22 is twisted with long side 23a of draw-out portion 22 and long side 28a of electrode portion 27 intersecting each other, due to cutout Nt formed in draw-out portion 22, the force in the twist direction generated in draw-out portion 22 during press molding can be absorbed. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, draw-out portion 22 may have a rectangular cross section perpendicular to draw-out direction Dr, and include long side 23a and short side 24a. Cutout length L in draw-out direction Dr may be 0.5 times or more and 1.5 times or less of the length of long side 23a.

With this configuration, draw-out portion 22 is configured to be twistable, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, cutout length L in draw-out direction Dr may be longer than cutout width w.

With this configuration, draw-out portion 22 is configured to be twistable, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, cutout Nt may be configured to have a narrower width in cutout center portion Ntc than in cutout end portion Nte in draw-out direction Dr.

As described above, by configuring cutout Nt to have a narrower width in center portion Ntc than in cutout end portion Nte, for example, the force in the twist direction generated in draw-out portion 22 during press molding can be absorbed. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, cutout depth dp may be 1.0 times or more and 3.0 times or less of cutout width w.

With this configuration, draw-out portion 22 is configured to be twistable, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, cutout Nt may be configured to have a greater depth in cutout center portion Ntc than in cutout end portion Nte in draw-out direction Dr.

With this configuration, draw-out portion 22 is configured to be twistable, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100A.

Also, draw-out portion 22 may have a rectangular cross section perpendicular to draw-out direction Dr and include long sides 23a and 23b and short sides 24a and 24b. Cutout Nt may be provided in each of long sides 23a and 23b and short sides 24a and 24b.

With this configuration, as a result of four cutouts Nt being formed in draw-out portion 22, draw-out portion 22 has a twistable cross section, and it is therefore possible to reduce, for example, a force in the twist direction generated in draw-out portion 22 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100C.

Also, draw-out portion 22 may have a rectangular cross section perpendicular to the draw-out direction, and include two long sides 23a and 23b and two short sides 24a and 24b. Cutout Nt may be provided in long side 23a that is one of the two long sides of draw-out portion 22 that is located farther away from center 21c of wound body portion 21.

For example, in the portion where cutout Nt has been formed, the insulation coating of the conductor wire is removed, and thus the conductor wire material is exposed. However, by providing cutout Nt in long side 23a that is one of the two long sides of draw-out portion 22 that is located farther away from center 21c of wound body portion 21, cutout Nt can be positioned away from wound body portion 21. With this configuration, it is possible to suppress a situation in which cutout Nt affects the characteristics of inductor 100, and also suppress the reduction of the reliability of inductor 100.

Also, draw-out portion 22 may have a rectangular cross section perpendicular to the draw-out direction, and include two long sides 23a and 23b and two short sides 24a, 24b. Cutout Nt may be provided in long side 23a that is one of the two long sides of draw-out portion 22 that is located farther away from center 21c of wound body portion 21, and also another cutout Nt may be provided in short side 24a that is one of the two short sides of draw-out portion 22 that is located farther away from winding axis AT of wound body portion 21.

For example, in each portion where cutout Nt has been formed, the insulation coating of the conductor wire is removed, and thus the conductor wire material is exposed. However, by providing cutout Nt in long side 23a that is one of the two long sides of draw-out portion 22 that is located farther away from center 21c of wound body portion 21, cutout Nt can be positioned away from wound body portion 21. Also, by providing another cutout Nt in short side 24a that is one of the two short sides of draw-out portion 22 that is located farther away from winding axis AT of wound body portion 21, cutout Nt can be positioned away from wound body portion 21. With this configuration, it is possible to suppress a situation in which cutouts Nt affect the characteristics of inductor 100D, and also suppress the reduction of the reliability of inductor 100D.

Also, cutout Nt may be provided between midpoint 22m of draw-out portion 22 in draw-out direction Dr and third surface 13c.

For example, in the portion where cutout Nt has been formed, the insulation coating of the conductor wire is removed, and thus the conductor wire material is exposed. However, by providing cutout Nt between midpoint 22m of draw-out portion 22 and third surface 13c, cutout Nt can be positioned away from wound body portion 21. With this configuration, it is possible to suppress a situation in which cutout Nt affects the characteristics of inductor 100E, and also suppress the reduction of the reliability of inductor 100D.

Also, the third surface may be composed of a plurality of third surfaces 13a, 13b, 13c, and 13d, and draw-out portion 22 may be composed of a plurality of draw-out portions 22, electrode portion 27 may be composed of a plurality of electrode portions 27, and the plurality of electrode portions 27 may protrude from third surface 13c that is the same one of the plurality of third surfaces 13a to 13d.

With this configuration, for example, wound body portion 21 is configured to be easily inclined relative to electrode portion 27 during press molding. Even with this configuration, the force in the twist direction generated in draw-out portion 22 can be reduced. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

A method for manufacturing an inductor according to the present embodiment includes: a coil element forming step of forming coil element 20 that includes wound body portion 21 formed by winding a flat conductor wire; and a magnetic dust core forming step of forming magnetic dust core 10 that includes coil element 20 by placing a portion of coil element 20 and a magnetic material in die 90 and subjecting to press molding. In the magnetic dust core forming step, the press molding is performed to provide wound body portion 21 and draw-out portion 22 drawn out from an end of wound body portion 21 inside of magnetic dust core 10 and electrode portion 27 connected to draw-out portion 22 outside of magnetic dust core 10. In the coil element forming step, cutout Nt that extends in draw-out direction Dr of draw-out portion 22 is formed at a position at which draw-out portion 22 is to be formed in the magnetic dust core forming step.

As described above, by providing cutout N in draw-out portion 22 of coil element 20, draw-out portion 22 is configured to be twistable. With this configuration, it is possible to reduce a force in the twist direction generated in draw-out portion 22 as a result of wound body portion 21 being inclined relative to electrode portion 27 during press molding. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

Also, cutout center portion Ntc in draw-out direction Dr may be narrower in width after the magnetic dust core forming step than before the magnetic dust core forming step.

As described above, as a result of draw-out portion 22 being twisted such that cutout center portion Ntc is narrower in width after the magnetic dust core forming step than before the magnetic dust core forming step, for example, the force in the twist direction generated in draw-out portion 22 during press molding can be absorbed. For this reason, it is possible to suppress shear damage to the conductor wire at the connecting portion where electrode 27 and draw-out portion 22 are connected. It is also possible to reduce a residual stress in the twist direction that remains in draw-out portion 22, and suppress damage to a portion of magnetic dust core 10 around draw-out portion 22 after press molding. Accordingly, it is possible to suppress the reduction of the reliability of inductor 100.

### Other Embodiments, Etc.

The inductors and the like according to the embodiment of the present disclosure and the variations of the present disclosure have been described above. However, the scope of the present disclosure is not limited to the embodiment and the variations given above. Other embodiments obtained by making various modifications that can be conceived by a person having ordinary skill in the art to the embodiment and the variations as well as embodiments constructed by combining some of the structural elements of the embodiment and the variations without departing from the spirit of the present disclosure are also encompassed within the scope of the present disclosure.

In the embodiment given above, an example was described in which cutout Nt is a groove with a V-shaped cross section. However, the configuration is not limited thereto, and cutout Nt may be a groove with a U-shaped cross section. Also, the method for forming cutout Nt is not limited to cutting processing. Cutout Nt may be formed by removing processing using a laser, a cutting tool, or the like.

Also, for example, electric products and electric circuits produced using the above-described inductor are also encompassed in the scope of the present disclosure. Examples of the electric products include a power supply device that includes the above-described inductor, various types of equipment that includes the power supply device, and the like.

### INDUSTRIAL APPLICABILITY

The inductor according to the present disclosure is useful as an inductor used in various types of devices and equipment, and the like.

### REFERENCE SIGNS LIST

10 magnetic dust core
11 first surface
12 second surface
13a, 13b, 13c, 13d third surface
20 coil element
21 wound body portion
21a one end
21b another end
21c center
22 draw-out portion
22m midpoint
23a, 23b long side
24a, 24b short side
27 electrode portion
28a, 28b long side
29a, 29b short side
90 die
91, 92 punch
93, 94 die
100, 100A, 100B, 100C, 100D, 100E, 100F inductor
AT winding axis
dp, dp1, dp2 cutout depth
Dr draw-out direction
L cutout length
Nt cutout
Ntc center portion
Nte end portion
w, w1, w2 cutout width

1. An inductor comprising:
a magnetic dust core including a first surface, a second surface opposite to the first surface, and at least one third surface that connects the first surface and the second surface; and
a coil element made of a flat conductor wire,
wherein the coil element includes: a wound body portion disposed inside of the magnetic dust core; a draw-out portion drawn out from an end of the wound body portion toward the at least one third surface; and an electrode portion that is connected to the draw-out portion and protrudes from the at least one third surface to outside of the magnetic dust core, and
the draw-out portion includes a cutout that extends in a draw-out direction of the draw-out portion.

2. The inductor according to claim 1,
wherein the cutout is a groove that extends in the draw-out direction.

3. The inductor according to claim 2,
wherein the groove has a V-shaped cross section perpendicular to the draw-out direction.

4. The inductor according to claim 1,
wherein the cutout is a through hole that extends in the draw-out direction.

5. The inductor according to claim 1,
wherein the cutout is in contact with the at least one third surface.

6. The inductor according to claim 1,
wherein the draw-out portion has a rectangular cross section perpendicular to the draw-out direction, the rectangular cross section including a long side and a short side, and
the cutout is provided at a center of the long side.

7. The inductor according to claim 1,
wherein when the inductor is viewed from the draw-out direction:
the draw-out portion has a rectangular cross section;
the electrode portion has a rectangular cross section; and
a long side of the rectangular cross section of the draw-out portion and a long side of the rectangular cross section of the electrode portion intersect each other.

8. The inductor according to claim 1,
wherein the draw-out portion has a rectangular cross section perpendicular to the draw-out direction, the rectangular cross section including a long side and a short side, and
a length of the cutout in the draw-out direction is 0.5 times or more and 1.5 times or less of a length of the long side.

9. The inductor according to claim 1,
wherein a length of the cutout in the draw-out direction is longer than a width of the cutout.

10. The inductor according to claim 1,
wherein the cutout has a narrower width in a center portion of the cutout than in an end portion of the cutout in the draw-out direction.

11. The inductor according to claim 1,
wherein a depth of the cutout is 1.0 times or more and 3.0 times or less of a width of the cutout.

12. The inductor according to claim 1,
wherein the cutout has a greater depth in a center portion of the cutout than in an end portion of the cutout in the draw-out direction.

13. The inductor according to claim 1,
wherein the draw-out portion has a rectangular cross section perpendicular to the draw-out direction, the rectangular cross section including a long side and a short side, and
the cutout is provided in each of the long side and the short side.

14. The inductor according to claim 1,
wherein the draw-out portion has a rectangular cross section perpendicular to the draw-out direction, the rectangular cross section including two long sides and two short sides, and
the cutout is provided in one of the two long sides that is located farther away from a center of the wound body portion.

15. The inductor according to claim 1,
wherein the draw-out portion has a rectangular cross section perpendicular to the draw-out direction, the rectangular cross section including two long sides and two short sides, and
the cutout is provided in one of the two long sides that is located farther away from a center of the wound body portion and one of the two short sides that is located farther away from a winding axis of the wound body portion.

16. The inductor according to claim 1,
wherein the cutout is provided between a midpoint of the draw-out portion in the draw-out direction and the at least one third surface.

17. The inductor according to claim 1,
wherein the at least one third surface includes a plurality of third surfaces,
the draw-out portion includes a plurality of draw-out portions,
the electrode portion includes a plurality of electrode portions, and
the plurality of electrode portions protrude from a same one of the plurality of third surfaces.

18. A method for manufacturing an inductor, the method comprising:
forming a coil element that includes a wound body portion obtained by winding a flat conductor wire; and
forming a magnetic dust core that includes the coil element by placing a portion of the coil element and a magnetic material in a die and subjecting to press molding,
wherein, in the forming of the magnetic dust core, the press molding is performed to provide the wound body portion and a draw-out portion drawn out from an end of the wound body portion inside of the magnetic dust core and an electrode portion connected to the draw-out portion outside of the magnetic dust core, and
in the forming of the coil element, a cutout that extends in a draw-out direction of the draw-out portion is formed at a position at which the draw-out portion is to be formed in the forming of the magnetic dust core.

19. The method for manufacturing the inductor according to claim 18,
wherein a center portion of the cutout in the draw-out direction has a narrower width after the forming of the magnetic dust core than before the forming of the magnetic dust core.
